(19) United States
(12) Patent Application Publication
(10) Pub. No.: US 2014/0105241 A1
(43) Pub. Date: Apr. 17, 2014

(54) EXACT SOLUTION FOR TEMPERATURE GRADIENT BIFURCATION IN POROUS MEDIA

(71) Applicants: Kambiz Vafai, Mission Viejo, CA (US); Kun Yang, Wuhan (CN)

(72) Inventors: Kambiz Vafai, Mission Viejo, CA (US); Kun Yang, Wuhan (CN)

(73) Assignee: Kambix Innovations, LLC.

(21) Appl. No.: 13/649,329

(22) Filed: Oct. 11, 2012

(51) Int. Cl. G01N 25/18

(52) U.S. Cl. 374/44

(57) ABSTRACT

A method and system for analyzing temperature gradient bifurcation in a porous medium by studying the convective heat transfer process within a channel filled with a porous medium with internal heat generation is disclosed. A LTNE model can be employed to represent the energy transport within a porous medium. Exact solutions can be derived for both fluid and solid temperature distributions for two primary approaches for the constant wall heat flux boundary condition. The Nusselt number for the fluid at the channel wall is also obtained. The effects of pertinent parameters such as fluid and solid internal heat generations, Biot number, and a fluid-to-solid effective thermal conductivity ratio can be determined. It can be shown that internal heat generation in a solid phase is significant for heat transfer characteristics.

### CROSS-REFERENCE TO PROVISIONAL PATENT APPLICATION

This patent application claims the benefit under 35 U.S.C. §119(e) of U.S. Provisional Application Ser. No. 61/598,060 entitled, “Methods and Systems for Heat Flux Bifurcation in Porous Media,” which was filed on Feb. 13, 2012 and is incorporated herein by reference in its entirety.

### TECHNICAL FIELD

Embodiments are generally related to convective heat transfer in a porous medium. Embodiments also relate to temperature gradient bifurcation in porous media. Embodiments are additionally related to an exact solution for temperature gradient bifurcation in porous media.

### BACKGROUND OF THE INVENTION

Convective heat transfer in porous media is encountered in a wide variety of industrial applications such as thermal energy storage, nuclear waste repository, electronic cooling, geothermal energy utilization, petroleum industry, and heat transfer enhancement. A number of situations involve internal heat generation such as nuclear reactor applications, agricultural product storage, electronic cooling, or a solar air heater packed with a porous medium where the packed material provides the heat transfer enhancement and also acts as an absorbing media for the solar radiation. See Ramadan, M. R. I., E1-Sebaii, A. A., Aboul-Enein, S., and E1-Bialy, E., Thermal Performance of a packed bed double-pass solar air heater, Energy, 32 (2007) 1524-1535.

Two primary models, which can be utilized for representing heat transfer in a porous medium, are Local Thermal Equilibrium (LTE) and Local Thermal Non Equilibrium (LTNE). LTNE incorporates the temperature difference between the fluid and solid phases, thus resulting in different energy equations for the fluid and solid phases. Amiri and Vafai employed a generalized model for the momentum equation and LTNE to investigate the forced convective heat transfer within a channel with a constant wall temperature. See Amiri, A., and Vafai, K., Analysis of Dispersion Effects and Non-Thermal Equilibrium, Non-Darcian, Variable Porosity Incompressible Flow Through Porous Medium, International Journal of Heat and Mass Transfer, 37 (1994) 939-954. They investigated in detail the inertial and boundary effects, porosity variation, thermal dispersion, and the validity of local thermal equilibrium as well as other pertinent effects.

Amiri et al. presented for the first time two primary approaches for the constant wall heat flux boundary conditions under the local thermal non-equilibrium condition in porous media. Based on the two-equation model (LTNE), and using one of the two primary approaches given in Amiri et al., Lee and Vafai investigated the forced convective flow through a channel filled with a porous media subject to a constant heat flux, and derived exact solutions for both fluid and solid phase temperature fields. See Amiri, A., and Vafai, K., and Kuzay, T. M., Effect of Boundary Conditions on Non-Darcian Heat Transfer Through Porous Media and Experimental Comparisons, Numerical Heat Transfer Journal Part A, 27 (1995) 651-664, Lee, D N., and Vafai, K., Analytical Characterization and Conceptual Assessment of Solid and Fluid Temperature Differentials in Porous Media, International Journal of Heat and Mass Transfer, 42 (1999) 423-435.

Marafie, A, and Vafai, K., Analysis of Non-Darcian effects on Temperature Differentials in Porous Media, International Journal of Heat and Mass Transfer, 44 (2001) 4401-4411, obtained analytical solutions for the fluid and solid phase temperature distributions for the forced convective flow through a channel filled with a porous medium with a constant heat flux boundary condition, in which the Brinkman-Forchhiemer-extended Darcy equation was used to obtain the velocity field. Alazmi, B., and Vafai, K., Constant Wall Heat Flux Boundary Conditions in Porous Media under Local Thermal Non-Equilibrium Conditions, International Journal of Heat and Mass Transfer, 45 (2002) 3071-3087, presented a comprehensive analysis of the effect of using different boundary conditions for the case of constant wall heat flux under the local thermal non-equilibrium condition.

Therefore, a need exists for revealing the phenomenon of analyzing temperature gradient bifurcation in a porous medium by studying the convective heat transfer process within a channel filled with a porous medium, with internal heat generation.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for convective heat transfer in a porous medium.

It is another aspect of the disclosed embodiments to provide for temperature gradient bifurcation in porous media.

It is a further aspect of the present invention to provide an exact solution for temperature gradient bifurcation inside porous media.

It is a further aspect of the present invention to provide for a method and system for analyzing temperature gradient bifurcation in a porous medium by studying the convective heat transfer process within a channel filled with a porous medium, with internal heat generation.

The aforementioned aspects and other objectives and advantages can now be achieved as described herein. The phenomenon of temperature gradient bifurcation in a porous medium is analyzed by studying the convective heat transfer process within a channel filled with a porous medium, with internal heat generation. A Local Thermal Non-Equilibrium (LTNE) model is used to represent the energy transport within the porous medium. Exact solutions are derived for both the fluid and solid temperature distributions for two primary approaches for the constant wall heat flux boundary condition. The Nusselt number for the fluid at the channel wall is also obtained. The effects of the pertinent parameters such as fluid and solid internal heat generations, Biot number, and fluid to solid thermal conductivity ratio are discussed. It is shown that the internal heat generation in the solid phase is significant for the heat transfer characteristics. The validity of the one equation model is investigated by comparing the Nusselt number obtained from the LTNE mod& with that from the LTE model.

The results demonstrate the importance of utilizing the LTNE model in the present study. The phenomenon of temperature gradient bifurcation for the fluid and solid phases at the wall for Model A is established and demonstrated. In addition, the temperature distributions for Models A and B are compared. A numerical study for the constant temperature boundary condition was also carried out. It was established that the phenomenon of temperature gradient bifurcation for the fluid and solid phases for the constant temperature boundary condition can occur over a given axial region.

It is to be understood that both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic diagram of a physical model and the corresponding coordinate system showing a flow through a channel filled with a porous medium, in accordance with the disclosed embodiments;

FIGS. 2A-2D illustrate graphs showing dimensionless temperature distributions for fluid and solid phases for Models A and B for β=5 with Bi=0.5 and k=0.01; Bi=50 and k=0.01; Bi=0.5 and k=10; Bi=50 and k=10 respectively, in accordance with the disclosed embodiments;

FIGS. 3A-3D illustrate graphs showing dimensionless temperature distributions for Models A and B for β=−5 with Bi=0.5 and k=0.01; Bi=50 and k=0.01; Bi=0.5 and k=10; and Bi=50 and k=10 respectively, in accordance with the disclosed embodiments;

FIG. 4 illustrates graph showing the variations of β₁ as a function of pertinent parameters Bi and k, in accordance with the disclosed embodiments;

FIG. 5 illustrates graph showing the variations of β₂ as a function of pertinent parameters Bi and k, in accordance with the disclosed embodiments;

FIGS. 6A-6C illustrate graphs showing Nusselt number variations as a function of pertinent parameters β, Bi and k, β=5; β=−0.5; β=−50, respectively, in accordance with the disclosed embodiments;

FIG. 7 illustrates graphs showing the variations of β₃ as a function of pertinent parameters Bi and k, in accordance with the disclosed embodiments;

FIGS. 8A-8C illustrate a graph showing Nusselt number based error maps when using the LTE model instead of the LTNE model for β=5; β=−0.5; β=−50, respectively, in accordance with the disclosed embodiments;

FIGS. 9A-9C illustrate graphs showing dimensionless temperature distributions for the solid and the fluid for constant temperature boundary condition for Bi=0.5, k=0.01, θ16.64,

$$\frac{{S}_{f}}{{S}_{s}} = \frac{1}{5}$$

and Re=500 at ξ=2, ξ=5, ξ=40, respectively, in accordance with the disclosed embodiments; and

FIG. 10 illustrates graphs showing heat flux distributions for the solid and the fluid at the wall, qₛ and q_{f}, and the corresponding total heat flux distribution, q_{w} for the constant temperature boundary condition for Bi=0.5, k=0.01, θᵢₙ=−16.64,

$$\frac{{S}_{f}}{{S}_{s}} = \frac{1}{5}$$

and Re=500, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The following Table 1 provides the various symbols and meanings used in this section:

TABLE 1

| | |
|---|---|
| Bi | $Bi = \frac{{h}_{i} {αH}^{2}}{{k}_{s , eff}} , Biot number defined by equation ( 13 )$ |
| cₚ | specific heat of the fluid [J kg⁻¹ K⁻¹] |
| E | $E = \frac{{Nu}_{1} - Nu}{Nu} , error in the Nusselt number defined by equation ( 73 )$ |
| hᵢ | interstitial heat transfer coefficient [W m⁻² K⁻¹] |
| h_{w} | wall heat transfer coefficient defined by equation (25) [W m⁻² K⁻¹] |
| h_{w1} | wall heat transfer coefficient calculated from one equation model, |
| | defined by equation (32) [W m⁻² K⁻¹] |
| H | half height of the channel [m] |
| k | $\begin{matrix}k = \frac{{k}_{f , eff}}{{k}_{s , eff}} , ratio of the fluid effective thermal conductivity to that of the solid , \\ defined by equation ( 12 )\end{matrix}$ |
| k_{f,eff} | effective thermal conductivity of the fluid [W m⁻² K⁻¹] |
| k_{s,eff} | effective thermal conductivity of the solid [W m⁻² K⁻¹] |
| Nu | Nusselt number for the LTNE model, defined by equation (26) |
| Nu₁ | Nusselt number for the LTE model, defined by equation (33) |
| q_{w} | heat flux at the wall [W m⁻²] |
| Q | integrated internal heat transfer exchange between the solid and fluid |
| | phases [W m⁻²] |
| Re | $Re = \frac{u ( 4 H )}{{v}_{f}} , Reynolds number$ |
| S_{f} | internal heat generation within the fluid phase [W m⁻³] |
| Sₛ | internal heat generation within the solid phase [W m⁻³] |
| T | temperature [K] |
| u | fluid velocity [m s⁻¹] |
| x | longitudinal coordinate [m] |
| y | transverse coordinate [m] |

Greek symbols

| | |
|---|---|
| Δθ | non-dimensional temperature difference, Δθ = θₛ − θ_{f} |
| α | interfacial area per unit volume of the porous medium [m⁻¹] |
| β | $β = \frac{{S}_{s} H}{{q}_{w}} , parameter defined by equation ( 14 )$ |
| β₁ | ${β}_{1} = \frac{λ}{1 + k \text{?} {tan}_{\text{?}} h λ} {-}_{\text{?}} \frac{1}{1 + k} , parameter defined by equation ( 56 )$ |
| β₂ | ${β}_{2} = \frac{λk}{1 + k \text{?} {tan}_{\text{?}} h λ} {-}_{\text{?}} \frac{1}{1 + k} , parameter defined by equation ( 57 )$ |
| β₃ | ${β}_{3} = \frac{λ}{3 [ 1 - \frac{1}{λ} tanh λ ]} {-}_{\text{?}} \frac{1}{1 + k} , parameter defined by equation ( 70 )$ |
| η | non-dimensional transverse coordinate, defined by equation (6b) |
| ξ | non-dimensional axial length scale, defined by equation (51) |
| θ | non-dimensional temperature, defined by equation (6a) for Model A, |
| | defined by equations (36) and (37) for Model B, or defined by equation |
| | (50) for constant temperature case |
| θ_{b} | non-dimensional bulk mean temperature for the LTE model |
| θ_{f,b} | non-dimensional bulk mean temperature of the fluid, defined by equation (24) |
| λ | parameter defined by equation (21) |
| ρ | fluid density [kg m⁻³] |

Subscripts

| | |
|---|---|
| f | fluid phase |
| s | solid phase |
| w | wall |

Other symbols

| | |
|---|---|
| [symbol] [symbol] | average over the channel cross section |

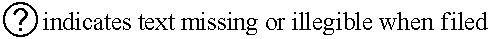

The present invention analyzes the temperature gradient bifurcation phenomenon in porous media by investigating the heat transfer characteristics for convection through a channel filled with a porous medium, with internal heat generation in both the fluid and solid phases, and subject to a constant heat flux boundary condition. The analytical solutions for the fluid and solid phase temperature distributions and the Nusselt number at the channel wall are obtained. The effects of pertinent parameters such as internal heat generation, Biot number, and thermal conductivity ratio are discussed. By comparing the Nusselt number obtained from the two-equation (LTNE) model with that from the one-equation (LTE) model, the validity of the one equation model is investigated. In addition, the temperature distributions for two different approaches for the constant wall heat flux boundary condition are compared. Furthermore, a numerical study for the constant temperature boundary condition was also carried out to investigate the temperature gradient bifurcation for that case.

### 1. Modeling and Formulation

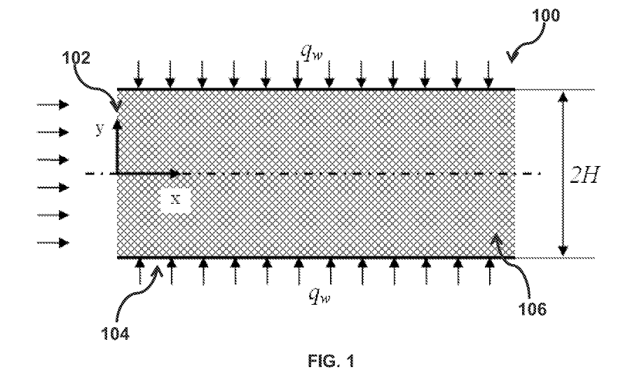

The schematic diagram of a physical model and the corresponding coordinate system 100 of the present invention is shown in FIG. 1. Fluid can flow through a rectangular channel 104 filled with a porous medium 106 subject to a constant heat flux boundary condition. Consider uniform but different internal heat generations in both the solid and fluid phases, Sₛ and S_{f}, respectively. The height of the channel is 2H and the heat flux applied at the wall is q_{w}. The assumptions that are invoked in the analyzing the problem are the flow is steady and incompressible, natural convection and radiative heat transfer are negligible, properties such as porosity, specific heat, density and thermal conductivity are assumed to be constant and thermally developed condition is considered and the fluid flow is represented by the Darcian flow model.

Based on the assumptions, the following governing equations are obtained from the works of Amid et al. employing the local thermal non-equilibrium model. See Amiri, A., and Vafai, K., Analysis of Dispersion Effects and Non-Thermal Equilibrium Non-Darcian, Variable Porosity Incompressible Flow Through Porous Medium, International Journal of Heat and Mass Transfer, 37 (1994) 939-954 and Amiri, A., and Vafai, K., and Kuzay, T. M., Effect of Boundary Conditions on Non-Darcian Heat Transfer Through Porous Media and Experimental Comparisons, Numerical Heat Transfer Journal Part A, 27 (1995) 651-664.

$$\begin{matrix}Fluid phase & \\ {k}_{f , eff} \frac{{\partial }^{2} {T}_{f}}{\partial {y}^{2}} + {h}_{i} α ( {T}_{s} - {T}_{f} ) + {S}_{f} = ρ {c}_{p} u \frac{\partial {T}_{f}}{\partial x} & Eq . ( 1 ) \\ Solid phase & \\ {k}_{s , eff} \frac{{\partial }^{2} {T}_{s}}{\partial {y}^{2}} - {h}_{i} α ( {T}_{s} - {T}_{f} ) + {S}_{s} = 0 & Eq . ( 2 )\end{matrix}$$

where T_{f} and Tₛ are the fluid and solid temperatures, u the fluid velocity, k_{f,eff}, and k_{s,eff} the effective fluid and solid thermal conductivities, respectively, ρ and cₚ the density and specific heat of the fluid, hᵢ the interstitial heat transfer coefficient, and α is the interfacial area per unit volume of the porous medium.

### 1.1 Boundary Conditions [Model A]

When a solid substrate of finite thickness and high thermal conductivity is attached to the porous medium 106 as shown in FIG. 1, the temperature of the solid and fluid at the wall interface will be the same as in Lee, D. Y., and Vafai, K., Analytical Characterization and Conceptual Assessment of Solid and Fluid Temperature Differentials in Porous Media, International Journal of Heat and Mass Transfer, 42 (1999) 423-435 and Marafie, A, and Vafai, K., Analysis of Non-Darcian effects on Temperature Differentials in Porous Media, International Journal of Heat and Mass Transfer, 44 (2001) 4401-4411.

T_{f}|_{y=H}=Tₛ|_{y=H}=T_{w} Eq. (3)

where T_{w} is the temperature at the wall interface.

Based on the work of Amiri, A., and Vafai, K., and Kuzay, T. M., Effect of Boundary Conditions on Non-Darcian Heat Transfer Through Porous Media and Experimental Comparisons, Numerical Heat Transfer Journal Part A, 27 (1995) 651-664, the total heat flux q_{w} can be divided between the fluid and solid phases depending on the physical values of their effective conductivities and their corresponding temperature gradients at the wall.

$${q}_{w} = {k}_{f , eff} \frac{\partial {T}_{f}}{\partial y} {{\vert}_{y = H} + {k}_{ɛ , eff} \frac{\partial {T}_{y}}{\partial y} \vert}_{y = H} \qquad Eq . ( 4 )$$

In this part, we utilize the approach for the constant heat flux boundary condition given by equations (3) and (4) and discussed in detail in Amiri et al. and Alazmi and Vafai as Model A. See Amiri, A., and Vafai, K., and Kuzay, T. M., Effect of Boundary Conditions on Non-Darcian Heat Transfer Through Porous Media and Experimental Comparisons, Numerical Heat Transfer Journal Part A, 27 (1995) 651-664 and Alazmi, B., and Vafai, K., Constant Wall Heat Flux Boundary Conditions in Porous Media under Local Thermal Non-Equilibrium Conditions, International Journal of Heat and Mass Transfer, 45 (2002) 3071-3087.

Due to the symmetry condition at the center of the channel, the following boundary condition can be used:

$$\frac{\partial {T}_{f}}{\partial y} {{\vert}_{y = 0} = \frac{\partial {T}_{s}}{\partial y} \vert}_{y = 0} = 0 \qquad Eq . ( 5 )$$

### 1.2 Normalization

To normalize the governing equation and the boundary conditions, the following dimensionless variables are introduced:

$$\begin{matrix}θ = \frac{{k}_{s , eff} ( T - {T}_{w} ) / H}{{q}_{w}} & Eq . ( 6 a ) \\ η = \frac{h}{H} & Eq . ( 6 b )\end{matrix}$$

Adding governing equations (1) and (2), and integrating the resultant equation from the center to the wall and applying the boundary conditions given by equations (3), (4), and (5), the following equation is obtained

$$ρ {c}_{p} 〈 u 〉 〈 \frac{\partial {T}_{f}}{\partial x} 〉 = \frac{{q}_{w}}{H} + {S}_{f} + {S}_{s} \qquad Eq . ( 7 )$$

where [symbol] [symbol] refers to the area average over the channel cross section. Using equations (6) and (7), and the Darcian flow model, the governing equations (1) and (2) and boundary conditions (3) and (5) can be rewrittten as:

$$\begin{matrix}l \frac{{\partial }^{2} {θ}_{f}}{\partial {η}^{2}} + Bi ( {θ}_{s} - {θ}_{f} ) = 1 + β & Eq . ( 8 ) \\ \frac{{\partial }^{2} {θ}_{s}}{\partial {η}^{2}} - Bi ( {θ}_{s} - {θ}_{f} ) + β = 0 & Eq . ( 9 ) \\ {θ}_{f} {{\vert}_{η = 1} = {θ}_{3} \vert}_{η = 1} = 0 & Eq . ( 10 ) \\ \frac{\partial {θ}_{f}}{\partial η} {{\vert}_{η = 0} = \frac{\partial {θ}_{s}}{\partial η} \vert}_{η = 0} = 0 & Eq . ( 11 )\end{matrix}$$

where the thermal conductivity ratio, k, Biot number, Bi and β are defined as:

$$\begin{matrix}k = \frac{{k}_{f , eff}}{{k}_{s , eff}} & Eq . ( 12 ) \\ Bi = \frac{{h}_{i} α {H}^{2}}{{k}_{s , eff}} & Eq . ( 13 ) \\ β = \frac{{S}_{s} H}{{q}_{w}} & Eq . ( 14 )\end{matrix}$$

Based on equations (8-14), it is obvious that the uniform internal heat generation in the fluid phase, S_{f}, has no influence on the dimensionless temperature distributions, θₛ and θ_{f}. However, S_{f} has an influence on the dimensional temperature distributions, Tₛ and T_{f}.

### 1.3 Temperature Distribution

Utilizing the two coupled governing equations (8) and (9), which involve two unknown functions, θ_{f} and θₛ, the following governing equations for the fluid and solid temperatures are obtained.

kθ″″_{f}(1+k)Biθ″_{f}=−Bi Eq. (15)

kθ″″ₛ(1+k)Biθ″ₛ=−Bi Eq. (16)

Two more sets of boundary conditions are required to solve the above fourth-order differential equations in addition to the boundary conditions given by equation (10) and (11). By utilizing the boundary conditions (10) and (11) in equations (8) and (9), the following equations are obtained.

θ″_{f}(1)=(1+β)/k, θ″ₛ(1)=−β Eq. (17)

θ′″_{f}(0)=θ′″ₛ(0)=0 Eq. (18)

The temperature distribution is found by solving equations (15) and (16) and applying the boundary equations (10), (11), (17) and (18). The resultant equations are

$$\begin{matrix}{θ}_{f} = \frac{1}{1 + k} \{ \frac{1}{2} {η}^{2} - 1 + ( \frac{1}{1 + k} + β ) \frac{1}{Bi} [ \frac{cosh λη}{cosh λ} - 1 ] \} & Eq . ( 19 ) \\ {θ}_{s} = \frac{1}{1 + k} \{ \frac{1}{2} {η}^{2} - 1 + ( \frac{1}{1 + k} + β ) \frac{k}{Bi} [ \frac{cosh λη}{cosh λ} ] \} \\ where & Eq . ( 20 ) \\ λ = \sqrt{Bl 1 + k / k} & Eq . ( 21 )\end{matrix}$$

When there is no internal heat generation in a porous medium, β=0, and equations (19) and (20) will transform into the analytical expressions given in Lee, D. Y., and Vafai, K., Analytical Characterization and Conceptual Assessment of Solid and Fluid Temperature Differentials in Porous Media, International Journal of Heat and Mass Transfer, 42 (1999) 423-435.

Based on equations (19) and (20), the temperature difference between the solid and fluid phases is derived as:

$$Δ θ {\vert}_{Model} - {θ}_{s} - {θ}_{f} - ( \frac{1}{1 + k} + β ) \frac{1}{Bi} [ 1 - \frac{cosh λη}{cosh λ} ] \qquad Eq . ( 22 )$$

Considering when

$$\frac{\partial \vert Δθ \vert}{\partial η} = 0 ,$$

the maximum |Δθ| is derived as:

$${\vert Δθ \vert}_{ModAe , max} = \vert \frac{1}{1 + k} + β \vert \frac{1}{Bi} [ 1 - \frac{1}{cosh λ} ] \qquad Eq . ( 23 )$$

### 1.4 Nusselt Number Expressions

Using equation (19), the non-dimensional bulk mean temperature of the fluid can be calculated as

$${θ}_{f , b} = \frac{{\int }_{0}^{1} η u d η}{〈 u 〉} = - \frac{1}{1 + k} \{ \begin{matrix}\frac{1}{3} + \\ ( \begin{matrix}\frac{1}{1 + k} + \\ β\end{matrix} ) \frac{1}{Bi} [ \begin{matrix}1 - \\ \frac{1}{λ} tanh λ\end{matrix} ]\end{matrix} \} \qquad Eq . ( 24 )$$

The wall heat transfer coefficient is obtained from

$${h}_{w} = \frac{{q}_{w}}{{T}_{w} - {T}_{f , b}} \qquad Eq . ( 25 )$$

and the Nusselt number from

$$Nu = \frac{{h}_{w} 4 H}{{k}_{f , eff}} = - \frac{4}{k {θ}_{f , b}} \qquad Eq . ( 26 )$$

where 4H is the hydraulic diameter of the channel. Substituting equation (24) in equation (26), results

$$Nu = \frac{41 + k}{k} {\{ \frac{1}{3} + ( \frac{1}{1 + k} + β ) \frac{1}{Bi} [ 1 - \frac{1}{λ} tanh \hat{λ} ] \}}^{- 1} \qquad Eq . ( 27 )$$

### 1.5 One Equation Model

The governing equation for the one equation model can be obtained by adding equations (8) and (9) and assuming that the temperatures of the fluid and solid phases are the same. This result in

$$\text{?} + 1 \frac{{\partial }^{2} θ}{\partial {η}^{2}} = 1 \\ \text{?} \text{indicates text missing or illegible when filed} \qquad Eq . ( 28 )$$

The corresponding boundary conditions are

$$\begin{matrix}θ {\vert}_{η = 1} = 0 & Eq . ( 29 ) \\ \frac{\partial θ}{\partial η} {\vert}_{η = 0} & Eq . ( 30 )\end{matrix}$$

The temperature distribution or the one equation model is derived as

$$θ = \frac{1}{21 + k \text{?}} {η}^{2} - 1 \\ \text{?} \text{indicates text missing or illegible when filed} \qquad Eq . ( 31 )$$

The wall heat transfer coefficient for the one equation model is obtained from

$${h}_{w 1} = \frac{{q}_{w}}{{T}_{w} - {T}_{b}} \qquad Eq . ( 32 )$$

where T_{b} is bulk mean temperature of the fluid. The Nusselt number for the one equation model is obtained as

$${N}_{{u}_{1}} = \frac{{h}_{w 1} 4 H}{{k}_{f , eff}} \text{?} - \frac{4}{k {θ}_{b}} = 12 \frac{1 + k}{k} \\ \text{?} \text{indicates text missing or illegible when filed} \qquad Eq . ( 33 )$$

Unlike the LTNE model, equations (31) and (33) show that the uniform internal heat generation in porous media has no influence on the dimensionless temperature distribution, θ, and the Nusselt number, Nu₁, for the LTE model. However, the heat generation plays a role in the dimensional temperature distribution for the LTE model.

### 1.6 Analytical Solutions for the Other Primary Constant Heat Flux Boundary Condition [Model B]

The other primary approach for handling the constant wall heat flux boundary is also based on the work presented by Amiri et al. and analyzed in detail in Alazmi and Vafai. For this case [Model B], the fluid phase or the solid phase at the wall are each exposed to a heat flux q_{w}. The corresponding representation for Model B is given by

$$\begin{matrix}{q}_{s , w} = {k}_{s , eff} \frac{\partial {T}_{s}}{\partial y} {\vert}_{y = H} = {q}_{w} & Eq . ( 34 ) \\ {q}_{f , w} = {k}_{f , eff} \frac{\partial {T}_{f}}{\partial y} {\vert}_{y = H} = {q}_{w} & Eq . ( 35 )\end{matrix}$$

The above approach for incorporating a constant heat flux boundary condition represented by equations (34) and (35) is defined as Model B.

It should be noticed that the temperature of the solid and the fluid at the wall interface may not be the same based on the boundary conditions (34) and (35). Therefore, the dimensionless temperature for the solid and fluid phases are redefined as

$$\begin{matrix}{θ}_{s} = \frac{{k}_{s , eff} ( {T}_{s} - {T}_{s , w} ) / H}{{q}_{w}} & Eq . ( 36 ) \\ {θ}_{f} = \frac{{k}_{s , eff} ( {T}_{f} - {T}_{s , w} ) / H}{{q}_{w}} & Eq . ( 37 )\end{matrix}$$

where T_{s,w} is the solid temperature at the wall. Adding governing equations (1) and (2) and integrating the resultant equation from the center to the wall and applying the boundary conditions given by equation (5), (34), and (35), the following equation is obtained.

$$ρ {c}_{p} 〈 u 〉 〈 \frac{\partial {T}_{f}}{\partial x} 〉 = \frac{2 {q}_{w}}{H} + {S}_{f} + {S}_{s} \qquad Eq . ( 38 )$$

Using equations (6b), (36), (37), and (38), and the Darcian flow model, the governing equations (1) and (2) and boundary conditions (5), (34), and (35) can be rewritten as:

$$\begin{matrix}k \frac{{\partial }^{2} {θ}_{f}}{\partial {η}^{2}} + Bi ( {θ}_{s} - {θ}_{f} ) = 2 + β & Eq . ( 39 ) \\ \frac{{\partial }^{2} {θ}_{s}}{\partial {η}^{2}} + Bi ( {θ}_{s} - {θ}_{f} ) + β = 0 & Eq . ( 40 ) \\ \frac{\partial {θ}_{f}}{\partial η} {\vert}_{η = 0} = \frac{\partial {θ}_{s}}{\partial η} {\vert}_{η = 0} = 0 & Eq . ( 41 ) \\ \frac{\partial {θ}_{f}}{\partial η} {\vert}_{η = 1} = \frac{1}{k} & Eq . ( 42 ) \\ {θ}_{s} {\vert}_{η = 1} = 0 & Eq . ( 43 )\end{matrix}$$

Based on equations (39-43), it can be deduced that the uniform internal heat generation in the fluid phase, S_{f}, has again no influence on the dimensionless temperature distributions, θₛ and θ_{f}, when Mod& B is used in applying the constant heat flux boundary condition. The temperature distribution is found by solving equations (39) and (40) and applying the boundary equations (41), (42), and (43).

The resultant equations are

$$\begin{matrix}{θ}_{f} = \frac{1 - k}{1 + k \text{?} sinh \text{?}} [ \frac{cosh \text{?} \text{?}}{k} \text{?} cosh \text{?} ] \text{?} \frac{{η}^{2} - 1}{1 + k} - \frac{2}{1 + k B \text{?}} - \frac{β}{B i} & Eq . ( 44 ) \\ {θ}_{s} = \frac{1 - k}{1 + k \text{?} sinh \text{?}} cosh \text{?} \text{?} cosh \text{?} \text{?} \text{?} \frac{\text{?} - 1}{1 + k} \\ \text{?} \text{indicates text missing or illegible when filed} & Eq . ( 45 )\end{matrix}$$

Based on equation (45), it is found that the uniform internal heat generation in the solid phase, Sₛ, has no influence on the dimensionless solid temperature distribution, θₛ, when Model B is used for the constant heat flux boundary condition. Furthermore, S_{f} has no influence on either θₛ or θ_{f}. However, again the heat generations have an influence on the dimensional temperature distributions. The temperature difference between the solid and fluid phases, when Model B is used for the constant heat flux, is derived as:

$$Δθ \vert \text{?} = {θ}_{s} - {θ}_{f} = \frac{k - 1}{1 + k \text{?} sin \text{?}} [ \frac{cos \text{?} \text{?}}{k} \text{?} cos \text{?} \text{?} ] ∓ \frac{2}{1 + k B \text{?}} + \frac{\text{?}}{B i} \\ \text{?} \text{indicates text missing or illegible when filed} \qquad Eq . ( 46 )$$

### 1.7 Constant Temperature Boundary Condition

The temperature gradient bifurcation was also examined numerically for the constant temperature boundary condition, while incorporating the axial conduction. The corresponding boundary conditions for the constant temperature condition were expressed as:

$$\begin{matrix}{T}_{f} {\vert}_{y = H} = {T}_{s} {\vert}_{y = H} = {T}_{w} & Eq . ( 47 ) \\ \frac{\partial {T}_{f}}{\partial y} {\vert}_{y = 0} = \frac{\partial {T}_{s}}{\partial y} {\vert}_{y = 0} = 0 & Eq . ( 48 ) \\ {T}_{f} {\vert}_{x = 0} = {T}_{s} {\vert}_{x = 0} = {T}_{i} , & Eq . ( 49 )\end{matrix}$$

The governing equations and the boundary conditions are solved using a finite difference method. Upwind discretization scheme is used for the convection term and central differencing is used for diffusion terms. Variable and uniform grid distributions were used for the y- and x-directions respectively. The convergence was assumed to have been reached when the relative variation of the temperature between two successive iterations was less than 10⁻¹⁰. The sensitivity to the grid interval and the convergence criteria were examined to insure grid independence results. The following dimensionless variables were introduced to show the results for this case.

$$\begin{matrix}θ = \frac{{k}_{s , eff} ( T - {T}_{w} )}{{S}_{s} {H}^{2}} & Eq . ( 50 ) \\ ξ = \frac{x}{H} & Eq . ( 51 ) \\ Re = \frac{u ( 4 H )}{{v}_{f}} & Eq . ( 52 )\end{matrix}$$

### 2. Results and Discussion

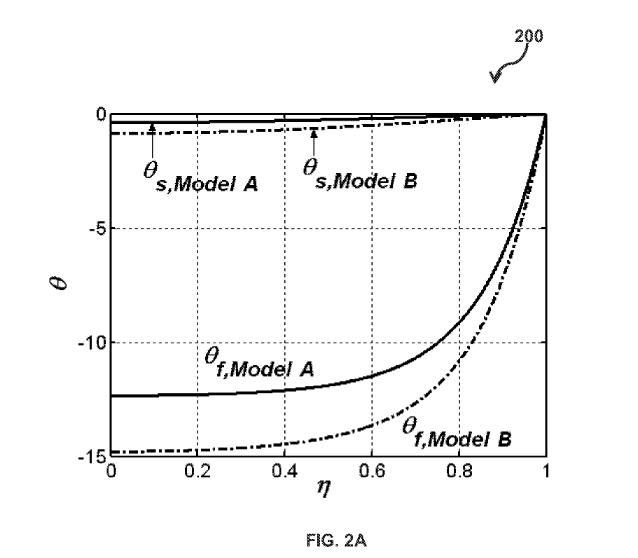

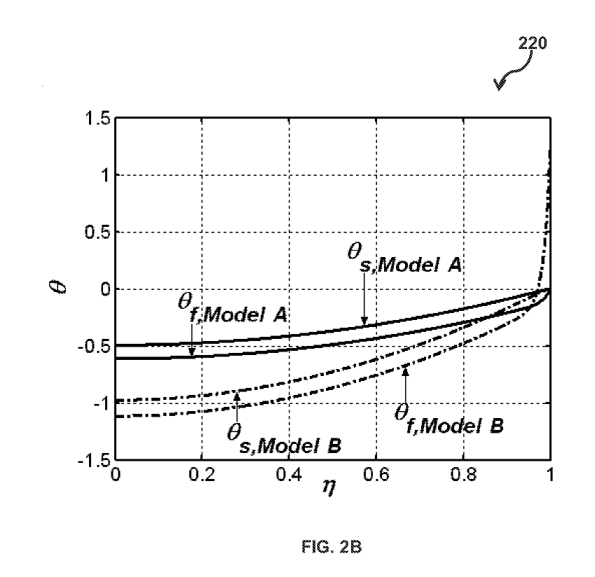

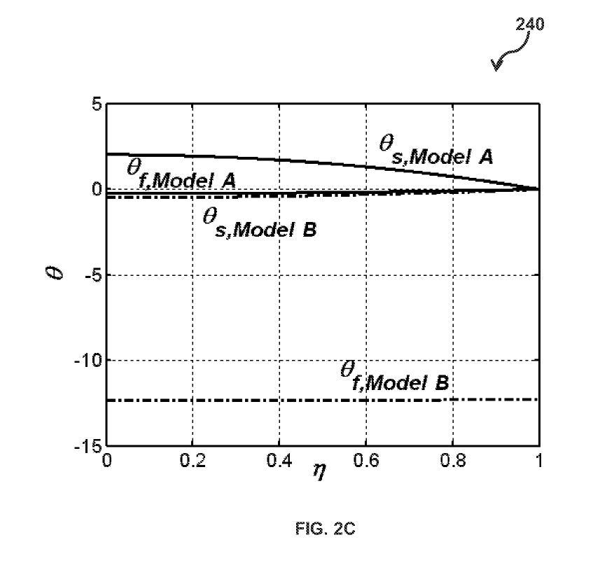

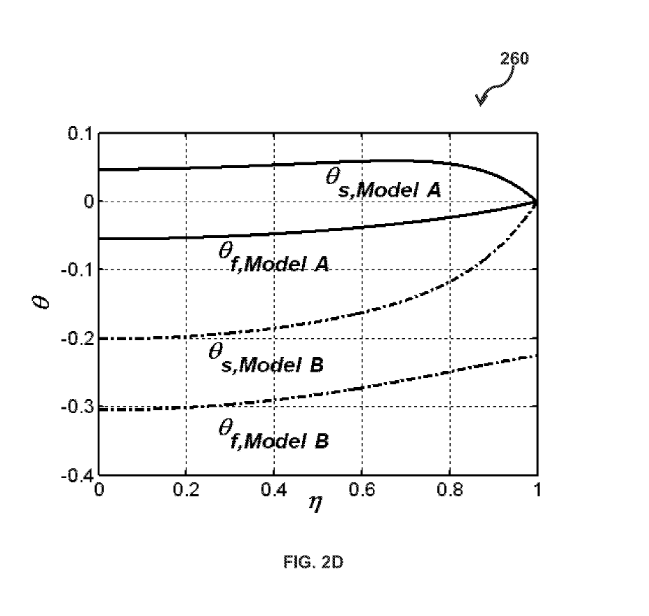

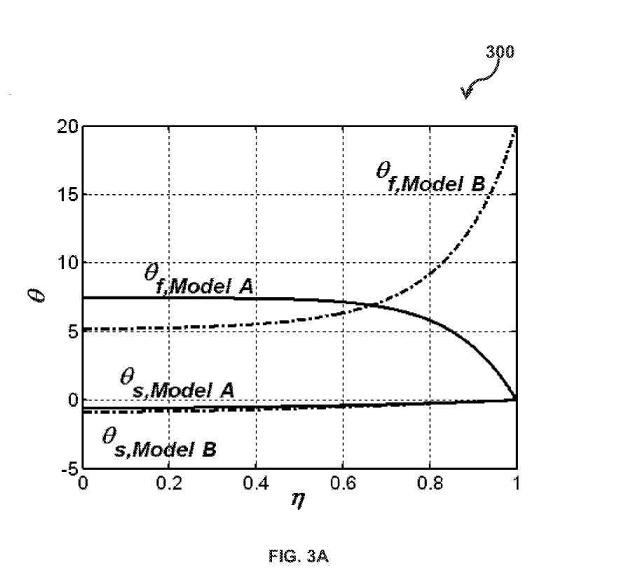

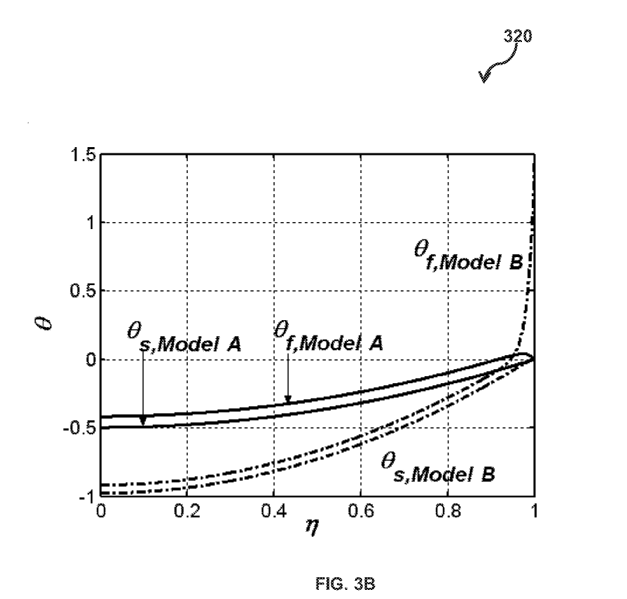

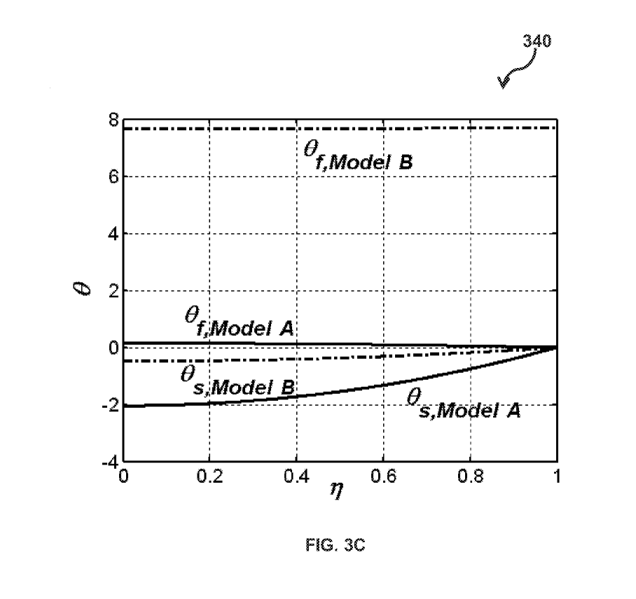

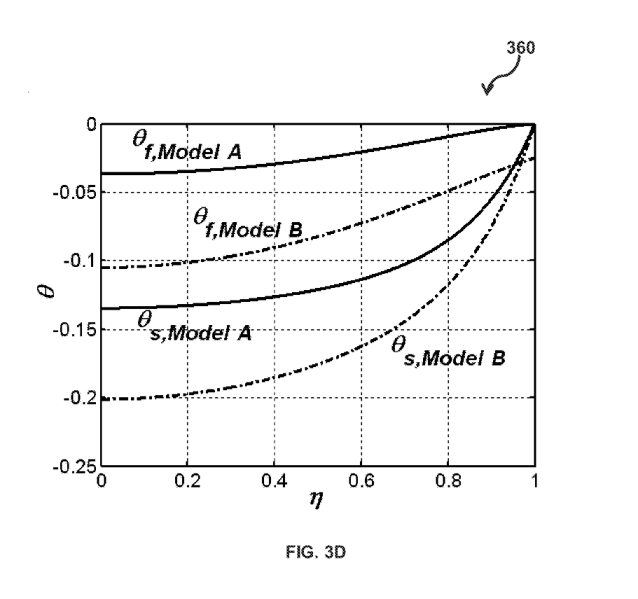

FIGS. 2A-2D illustrate graphs 200, 220, 240, and 260 showing dimensionless temperature distributions for fluid and solid phases for Models A and B for β=5 with Bi=0.5 and k=0.01 Bi=50 and k=0.01; Bi=0.5 and k=10; Bi=50 and k=10, respectively. FIGS. 3A-3D illustrate graphs 300, 320, 340, and 360 showing dimensionless temperature distributions for fluid and solid phases for Models A and B for β=−5 with Bi=0.5 and k=0.01; Bi=50 and k=0.01; Bi=0.5 and k=10, and Bi=50 and k=10, in accordance with the disclosed embodiments.

The dimensionless temperature distributions for the fluid and solid phases for Model A for different pertinent parameters β, Bi, and k are shown in the FIGS. 2A-2D and FIGS. 3A-3D. When Bi is small, which translates into a weak internal heat transfer between the fluid and solid phases, the temperature difference between the two phases is relatively large, especially for a small k, as shown in FIGS. 2A and 3A. As k increases, the influence of the fluid thermal conduction becomes significant over most of the channel.

It is important to note that the direction of the temperature gradient for the fluid and solid phases for Model A are different at the wall (η=1) in FIGS. 2C and 2D and FIGS. 3A-3C. This leads to a temperature gradient bifurcation for Model A for those cases. From equations (19) and (20), the temperature gradients at the wall for the fluid and solid for Model A are obtained as:

$$\begin{matrix} {θ}_{f}^{′} ( 1 ) = \frac{1}{1 + k} + [ \frac{1}{1 + k \text{?}} + \frac{β}{k} ] \frac{1}{λ} tanh ( λ ) & Eq . ( 53 ) \\ {θ}_{s}^{′} ( 1 ) = \frac{1}{1 + k} - [ \frac{1}{1 + k} \text{?} β ] \frac{1}{λ} tanh ( \text{?} ) \\ \text{?} \text{indicates text missing or illegible when filed} & Eq . ( 54 )\end{matrix}$$

If β satisfies the following condition, the direction of the temperature gradients for Model A at the wall for fluid and solid phases is different.

$$\begin{matrix} β > {β}_{1} or β < {β}_{2} & Eq . ( 55 ) \\ where , {β}_{1} = \frac{λ}{1 + k \text{?} λ} \text{?} \frac{1}{1 + k} & Eq . ( 56 ) \\ {β}_{2} = - \frac{λ k}{1 + k \text{?} λ} \text{?} \frac{1}{1 + k} \\ \text{?} \text{indicates text missing or illegible when filed} & Eq . ( 57 )\end{matrix}$$

It should be noted that

$$\frac{λ}{tanh \text{?} \text{?}} > 1$$

$$\text{?} \text{indicates text missing or illegible when filed}$$

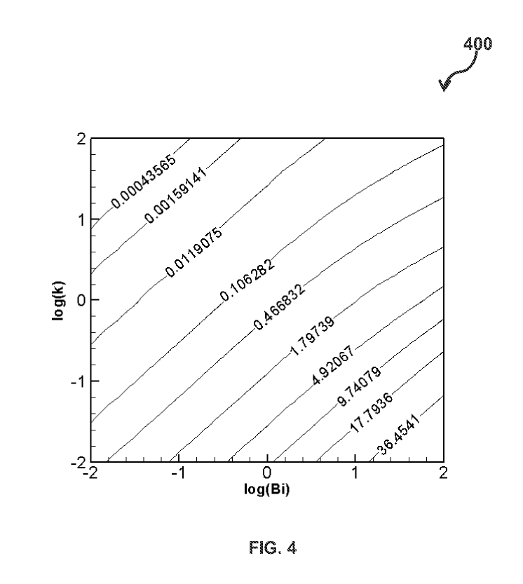

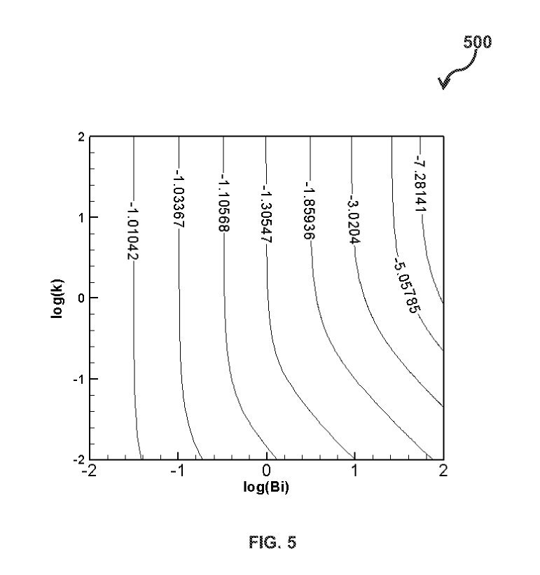

for λ>0. Therefore, β₁>0 and β₂<−1. The variations of β₁ and β₂ as a function of pertinent parameters Bi and k for Model A are shown in FIGS. 4 and 5 as graphs 400 and 500. β₁ is found to increase as Bi becomes larger and k becomes smaller, while β₂ decreases as Bi becomes larger.

When Model A is used for the constant wall heat flux boundary condition, the integrated internal heat transfer exchange between the solid and fluid phases is obtained from:

Q=∫₀^{h}hᵢa(Tₛ−T_{f})dy=q_{w}∫₀^{λ}Bi(θₛ−θ_{f})drᵢ Eq. (58)

Substituting equation (22) in equation (58), results in:

$$Q = {q}_{w} ( \frac{1}{1 + k} + β ) [ 1 - \frac{tanh λ}{λ} ] \qquad Eq . ( 59 )$$

The heat flux at the wall for the solid phase is obtained from:

$${ {q}_{s} = \text{?} \frac{\partial {T}_{s}}{\partial y} \vert}_{y = H} = {q}_{w} {θ}_{s}^{′} 1 \\ \text{?} \text{indicates text missing or illegible when filed} \qquad Eq . ( 60 )$$

Substituting equation (54) in equation (60), results in:

$${q}_{s} = {q}_{w} \{ \frac{1}{1 + k} - [ \frac{1}{1 + k} + β ] \frac{1}{λ} tanh ( λ ) \} \qquad Eq . ( 61 )$$

Based on equations (59) and (61), the difference between Q and qₛ can be expressed as

Q−qₛ=q_{w}β=SₛH Eq. (62)

when β>β₁ or β<β₂ and Sₛ>0, the following inequalities are obtained

SₛH>Q>0 and SₛH>−qₛ>0 Eq. (63)

It can be inferred from equations (62) and (63) that, when β>β₁ or β<β₂, and Sₛ>0, part of the internal heat generation in the solid phase will transfer to fluid phase through the thermal conduction at the wall instead of through internal heat transfer exchange between the fluid and solid. This paves the way for the occurrence of the temperature gradient bifurcation at the wall. When β=0, which translates into no internal heat generation, based on equation (55), the temperature gradient directions for the fluid and solid phases at the wall are kept the same. This explains why this phenomenon was not observed in the works of Lee and Vafai and Marafie and Vafai. See Lee, D. Y., and Vafai, K., Analytical Characterization and Conceptual Assessment of Solid and Fluid Temperature Differentials in Porous Media, International Journal of Heat and Mass Transfer, 42 (1999) 423-435 and Marafie, A, and Vafai, K., Analysis of Non-Darcian effects on Temperature Differentials in Porous Media, International Journal of Heat and Mass Transfer, 44 (2001) 4401-4411. In their works, the internal heat generation was not included.

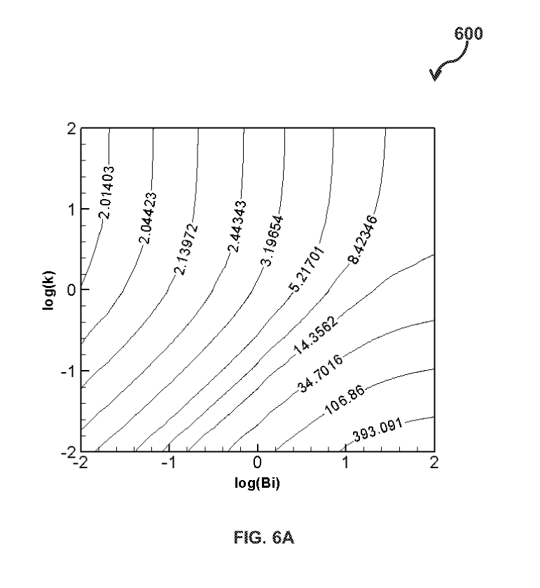

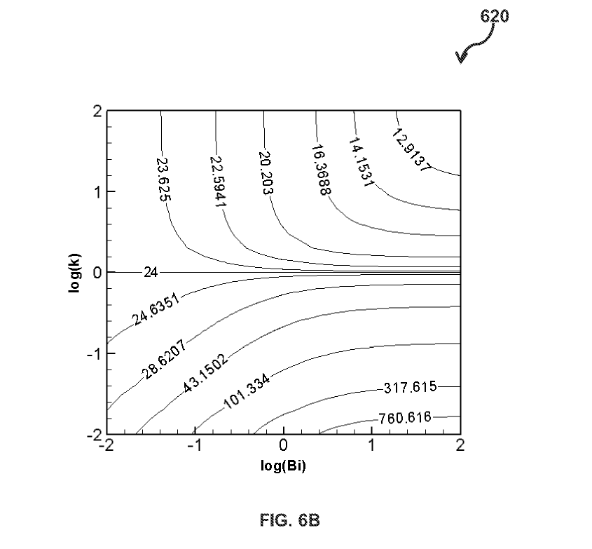

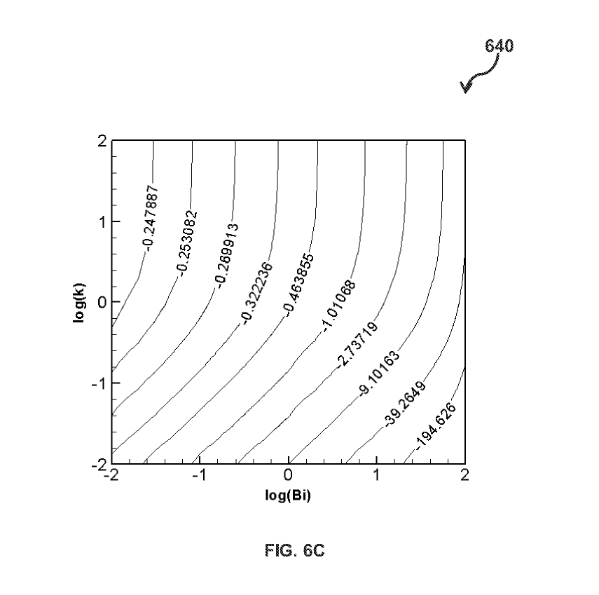

Unlike the Nusselt number for the one equation model (based on equation (33)), which is just the function of k, the variations of Nusselt number for two-equation model is a function of pertinent parameters β, Bi and k as shown in FIGS. 6A-6C as graphs 600, 620, and 640, which is based on equation (27). This figure reveals the asymptotic characteristics of the Nusselt number, which can be analyzed using the following relationship.

$$\frac{1}{λ} tanh λ \approx \{ \begin{matrix}1 - {λ}^{2} / 3 & as λ -> 0 \\ 0 & as λ -> ∞\end{matrix} \qquad Eq . ( 64 )$$

Based on equations (27) and (64), when λ→0, the asymptotic behavior of the Nusselt number, for Model A, is obtained as

$$Nu \approx \frac{12}{1 + β} \qquad Eq . ( 65 )$$

Based on the definition of λ, given in equation (21), the condition , λ→0, occurs when

$$Bi << \frac{k}{1 + k} \qquad Eq . ( 66 )$$

On the other hand, when λ→∞, the asymptotic behavior of the Nusselt number for Model A is obtained as

$$Ni \approx {\frac{41 + k}{k} [ \frac{1}{3} + ( \frac{1}{1 + k} + β ) \frac{1}{Bi} ]}^{- 1} \qquad Eq . ( 67 )$$

Furthermore, when Bi→∞ and |β|<<Bi, the Nusselt number approaches

$$\frac{12 ( 1 + k )}{k} ,$$

i.e.,

$$Nu \approx \frac{12 ( 1 + k )}{k} \qquad Eq . ( 68 )$$

This is the same as the Nusselt number for one equation model. This is because the temperature difference between the fluid and solid phases disappears as Bi→∞.

It could be seen in FIGS. 6A-6C that the Nusselt number for Model A could be either positive or negative for different ranges of β, Si, and k. Based on equation (27), if β satisfies the following condition, the Nusselt number, Nu, will be a positive number.

$$\begin{matrix}β > {β}_{3} & Eq . ( 69 ) \\ where {β}_{3} = - \frac{Bi}{3 [ 1 - \frac{1}{λ} tanh λ ]} - \frac{1}{1 + k} & Eq . ( 70 )\end{matrix}$$

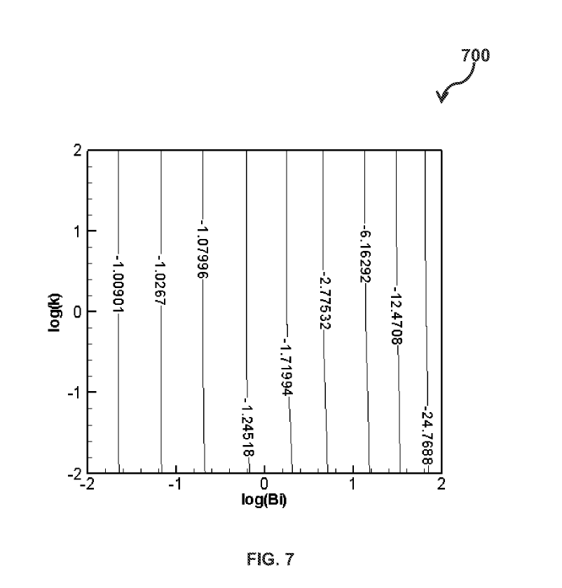

when β→β₃, the non-dimensionalized bulk mean temperature of the fluid, θ_{f,b}, approaches zero, and the Nusselt number approaches infinity. The variations of β₃ as a function of pertinent parameters Bi and k for Model A is shown as graph 700 in the FIG. 7. This figure reveals that the thermal conductivity ratio, k, has a substantially smaller influence on β₃ as compared to the Biot number. Comparing equations (57) and (70), one can conclude that

β_{3≦}β₂ Eq. (71)

However, when λ→0, β_{2≈}β₃→−1 Eq. (72)

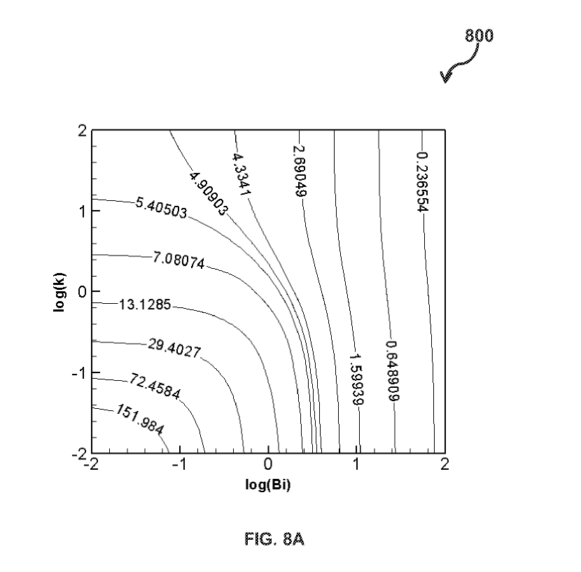

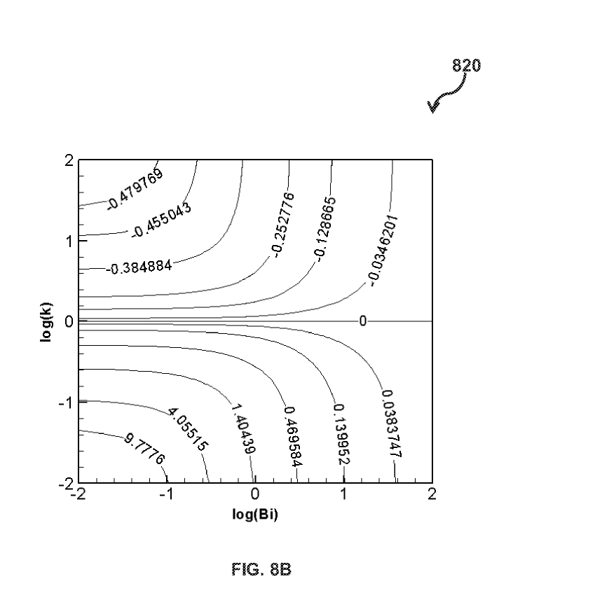

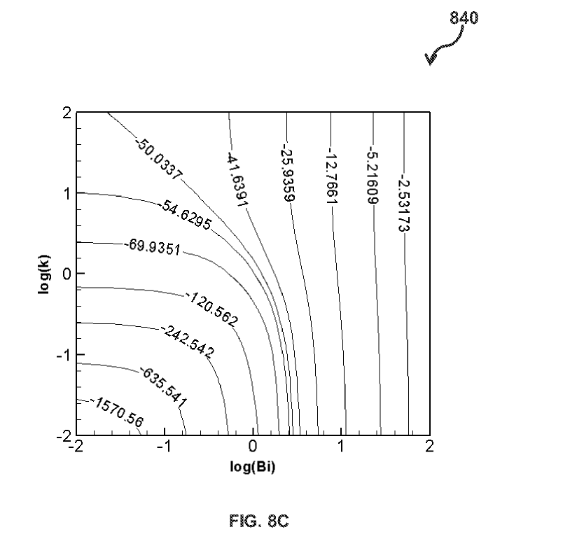

A comparison between the Nusselt number for the LTE Model and that for the LTNE model for the boundary conditions represented by Model A are shown in FIGS. 8A-8C as graphs 800, 820, and 840, in which the error in the Nusselt number based on using the LTE model is evaluated through the analytical solutions given in equations (27) and (33).

$$E = \frac{{Nu}_{1} - Nu}{Nu} = 3 ( \frac{1}{1 + k} + β ) \frac{1}{Bi} [ 1 - \frac{1}{λ} tanh λ ] \text{?} \\ \text{?} \text{indicates text missing or illegible when filed} \qquad Eq . ( 73 )$$

For most of the values of the pertinent parameters β, Bi, and k, for Model A, the error in using the one equation model is quite large as can be seen in FIGS. 8A-8C. This difference becomes smaller as the Biot number increases. It should be noted that, for β=−0.5, the error in using the one equation model becomes zero when k=1, as shown in FIG. 8B. Based on equations (22), when β=−1/(1+k), the temperature difference between the fluid and solid phases will disappear, and the Nusselt number for the two-equation model will collapse to that for the one equation model. This criterion is then expressed by:

$$β = - \frac{1}{1 + k} \qquad Eq . ( 74 )$$

This is also the reason why the Nusselt number is independent of the Biot number for k=1 in FIG. 6B. The dimensionless temperature distributions for the fluid and solid phases for Model B for different pertinent parameters β, Bi, and k are also shown in the FIGS. 2A-2D and 3A-3D. When Bi increases, the temperature difference between the two phases becomes smaller. Compared with the results for Model A, the temperature distributions for Model B are quite different. It is found that the temperature gradient for the fluid and solid phases for Model B are always in the same direction at the wall (η=1) in FIGS. 2A-2D and 3A-3D, which is consistent with the boundary condition equations (34) and (35).

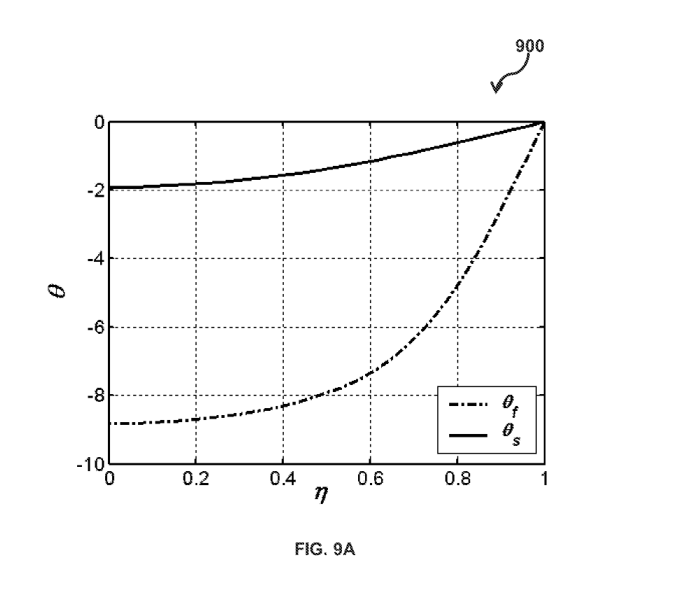

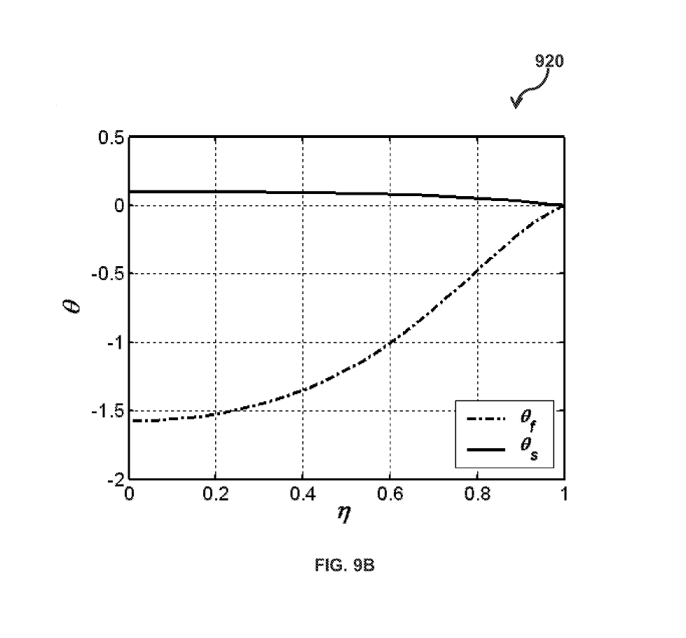

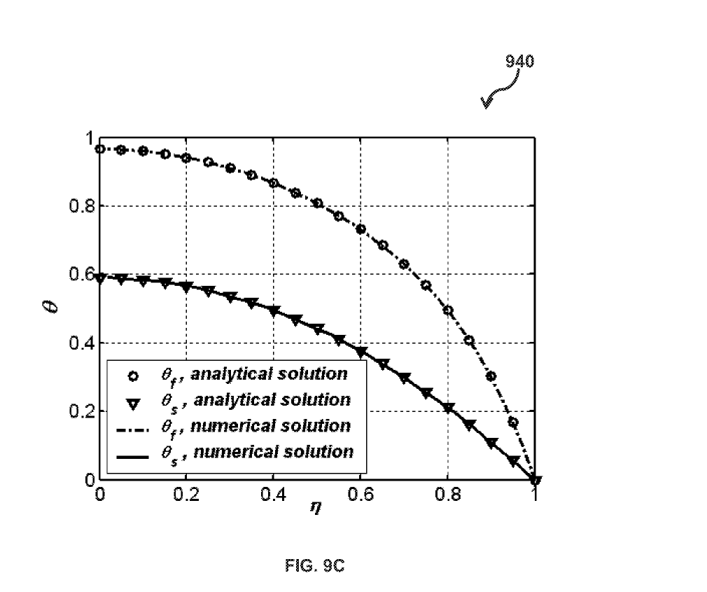

For the constant temperature boundary condition, the dimensionless temperature distributions for the solid and the fluid are shown in FIGS. 9A-9C as graphs 900, 920, and 940 for Bi=0.5, k=0.01, (6=-16.64,

$$\frac{{S}_{f}}{{S}_{s}} = \frac{1}{5}$$

and Re=500 at ξ=2, ξ=5, and ξ=40. It is found that for this case the phenomenon of temperature gradient bifurcation for the fluid and solid phases at the wall occurs only over a given axial region. For example, for the cited case it occurs at ξ=5, but not at ξ=2 and ξ=40. Another interesting aspect is that after a certain axial length, the temperature distribution results from the constant temperature case match the analytical results obtained for the constant heat flux case [Model A]. This situation can be seen in FIG. 9C.

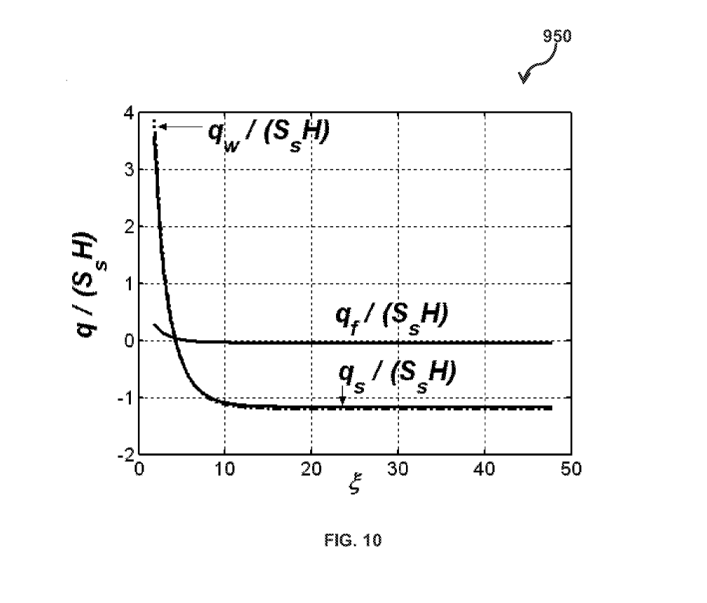

FIG. 10 illustrates a graph 950 showing the heat flux distributions for the solid and fluid at the wall, qₛ and q_{f}, and the corresponding total heat flux distribution, q_{w} for the constant temperature boundary condition for Bi=0.5, k=0.01, θᵢₙ=−16.64,

$$\frac{{S}_{f}}{{S}_{s}} = \frac{1}{5}$$

and Re=500. It is found that, when 4.24<ξ<5.53, qₛ<0, and q_{f}>0, i.e. the phenomenon of temperature gradient bifurcation for the fluid and solid phases at the wall will occur. When ξ>20, the total heat flux becomes invariant with the axial length, ξ, and q_{w}=−(Sₛ+S_{f})H. This is because when ξ is large enough, all the internal heat generation will be transferred out of the channel through the wall, and the temperatures for solid and fluid phases will remain unchanged. Since the total heat flux does not change when ξ is large enough, we should be able to use our analytical solution for Model A for the constant heat flux boundary condition for this case. Such a comparison was shown earlier in FIG. 9C. As was mentioned earlier, there is an excellent agreement between the constant temperature solution for larger values of ξ and the analytical solution for the constant heat flux case. It should be noted after the total heat flux becomes invariant, the corresponding p can he presented as

$${β}_{1} > β = - \frac{{S}_{y}}{{S}_{s} + {S}_{f}} > {β}_{2}$$

for Sₛ>0 and S_{f}>0. Therefore, based on equation (55), the phenomenon of temperature gradient bifurcation will not occur for larger values of ξ.

### 3. Conclusions

The phenomenon of temperature gradient bifurcation in a porous medium is analyzed in this work. To this end, convective heat transfer within a channel filled with a porous medium subject to a constant wall heat flux boundary condition, with internal heat generation in both the fluid and solid phases, is investigated analytically. A local thermal non-equilibrium (LTNE) model is used to represent the energy transport. Exact solutions are derived for both the fluid and solid temperature distributions for two different primary approaches (Models A and B) for the constant wall heat flux boundary condition. It is shown that the dimensionless temperature distributions for the two phases are independent of the internal heat generation of the fluid phase for both Models A and B. As expected, the temperature difference between the fluid and the solid phases is found to become smaller as the Biot number increases. When Model A is used for the constant wall heat flux boundary condition, the Nusselt number is obtained as a function of the pertinent parameters β, Biot number, Bi and thermal conductivity ratio, k. The internal heat generation in the solid phase is found to have a significant impact on the heat transfer characteristics represented by the parameter β. It is found that when β>β₁ or β<β₂, the phenomenon of temperature gradient bifurcation for the fluid and solid phases at the wall will occur when β→β₃, the Nusselt number will approach infinity when β=−1/(1+k), the fluid and solid phase temperatures become equal.

The validity of the one equation model is assessed by presenting an error map based on the obtained analytical Nusselt number expressions. It is shown that good agreement between the two models is obtained when or Bi→∞ or β=−1/(1+k).

When Model B is used for the constant wall heat flux boundary condition, the derived temperature distributions are different from those obtained for Model A. The phenomenon of opposite temperature gradient directions for the fluid and solid phases at the wall will not occur when Model B is used. It was shown that the temperature gradient bifurcation can also occur for the constant temperature boundary condition over a given axial length. It was shown that when the axial length is large enough, the temperature gradient bifurcation phenomenon does not occur and the analytical solution for Model A for the constant heat flux boundary condition can be used for the constant temperature boundary case.

Based on the foregoing, it can be appreciated that a method and system are disclosed herein for analyzing temperature gradient bifurcation in a porous medium by studying the convective heat transfer process within a channel filled with a porous medium with internal heat generation is disclosed. A LINE model can be employed to represent the energy transport within a porous medium. Exact solutions are derived for both fluid and solid temperature distributions for two primary approaches for the constant wall heat flux boundary condition. The Nusselt number for the fluid at the channel wall is also obtained. The effects of pertinent parameters such as fluid and solid internal heat generations, Biot number, and a fluid-to-solid effective thermal conductivity ratio can be determined. It is shown that internal heat generation in solid phase is significant for heat transfer characteristics. The validity of the one equation model is investigated by comparing the Nusselt number obtained from LTNE model with that from LTE model. The phenomenon of temperature gradient bifurcation for the fluid and solid phases at the wall for Model A for a constant heat flux boundary condition is established. This phenomenon can also occur over a given axial region for a constant temperature boundary condition.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing temperature gradient bifurcation in a porous medium, said system comprising:
analyzing convective heat transfer within a channel filled with a porous medium under a local thermal non-equilibrium condition;
deriving exact solutions for a fluid and a solid temperature distributions;
deriving a Nusselt number for said fluid at said channel wall;
determining internal heat generation in said fluid and solid phases;
comparing said Nusselt number obtained from said local thermal non-equilibrium condition with that from a local thermal equilibrium condition; and
disclosing a phenomenon of temperature gradient bifurcations for fluid and solid phases at said channel wall for a constant heat flux boundary condition.

2. The method of claim 1 further comprising obtaining effects of pertinent parameters including at least one of: fluid and solid internal heat generations, a Biot number, and a fluid-to-solid effective thermal conductivity ratio.

3. The method of claim 1 further comprising comparing temperature distributions for said local thermal non-equilibrium condition and said local thermal equilibrium condition.

4. The method of claim 1 wherein temperature gradient bifurcation for the fluid and solid phases for the constant temperature boundary condition occurs over a given axial region.

5. The method of claim 1 wherein dimensionless temperature distributions for the said fluid and solid phases are independent of the internal heat generation of the fluid phase for said local thermal non-equilibrium condition and said local thermal equilibrium condition.

6. The method of claim 1 wherein temperature difference between said fluid and solid phases is found to become smaller as Biot number increases.

7. A system for analyzing temperature gradient bifurcation in a porous medium, said system comprising:
means for analyzing convective heat transfer within a channel filled with a porous medium under a local thermal non-equilibrium condition;
means for deriving exact solutions for a fluid and a solid temperature distributions;
means for deriving a Nusselt number for said fluid at said channel wall;
means for determining internal heat generation in said fluid and solid phases;
means for comparing said Nusselt number obtained from said local thermal non-equilibrium condition with that from a local thermal equilibrium condition; and
means for disclosing a phenomenon of temperature gradient bifurcations for fluid and solid phases at said channel well for a constant heat flux boundary condition.

8. The system of claim 7 further comprising means for obtaining effects of pertinent parameters including at least one of: fluid and solid internal heat generations, a Biot number, and a fluid-to-solid effective thermal conductivity ratio.

9. The system of claim 7 further comprising means for comparing temperature distributions for said local thermal non-equilibrium condition and said local thermal equilibrium condition.

10. The system of claim 7 wherein temperature gradient bifurcation for the fluid and solid phases for the constant temperature boundary condition occurs over a given axial region.

11. The system of claim 7 wherein dimensionless temperature distributions for the said fluid and solid phases are independent of the internal heat generation of the fluid phase for said local thermal non-equilibrium condition and said local thermal equilibrium condition.

12. The system of claim 7 wherein temperature difference between said fluid and solid phases is found to become smaller as Biot number increases.
